(19) United States
(12) Patent Application Publication
(10) Pub. No.: US 2011/0228078 A1
(43) Pub. Date: Sep. 22, 2011

(54) REAL-TIME AUGMENTED REALITY DEVICE, REAL-TIME AUGMENTED REALITY METHOD AND COMPUTER STORAGE MEDIUM THEREOF

(75) Inventors: Yu-Chang CHEN, Taipei City (TW); Yung-Chih LIU, Taipei City (TW); Shih-Yuan LIN, Taipei City (TW)

(73) Assignee: INSTITUTE FOR INFORMATION INDUSTRY, Taipei (TW)

(21) Appl. No.: 12/815,901

(22) Filed: Jun. 15, 2010

(30) Foreign Application Priority Data
Mar. 22, 2010 (TW) 099108331

(51) Int. Cl. H04N 7/18

(52) U.S. Cl. 348/113; 348/E07.085

(57) ABSTRACT

A real-time augmented reality device, a real-time augmented reality method and a computer storage medium are provided. The real-time augmented reality device may work with a navigation device and an image capture device. The navigation device is configured to generate navigation information according to the current location of the navigation device. The image capture device is configured to capture the real-time image which comprises an object. The real-time augmented reality device is configured to generate the navigation image according to the real time image and the navigation information.

### PRIORITY

This application claims priority to Taiwan Patent Application No. 099108331 filed on Mar. 22, 2010, which is incorporated by reference herein in its entirety.

### FIELD

The present invention relates to a real-time augmented reality device, a real-time augmented reality method and a computer storage medium thereof. More specifically, the present invention relates to a real-time augmented reality device capable of generating a navigation image according to a real-time image and navigation information, a real-time augmented reality method and a computer storage medium thereof.

### BACKGROUND

The positioning and navigation system has found increasingly wider application with development of the associated technology. For example, by means of the technology of the positioning and navigation system, use of mobile phones, personal digital assistants (PDAs), automobiles and the like are made more convenient. Particularly, the most common use of the positioning and navigation system is found in onboard GPS positioning and navigation devices. Hereinafter, operating mechanism of a conventional onboard GPS positioning and navigation device will be described.

The global positioning system (GPS) is a kind of mid-range circular-orbit satellite system, which provides accurate positioning for most areas on the earth surface. The navigation system operates as follows: information such as longitude and latitude, direction, velocity, height and the like of vehicles are determined by means of the GPS; inertial navigation devices such as electronic compass, accelerometer, gyroscope and the like are used to assist in calculating information during a GPS information update period; then locations of the vehicles are located by using positioning information and map data, and traveling paths are determined; and finally, the current location and current traveling direction of the vehicles are displayed in form of a graph.

However, conventional onboard GPS positioning and navigation systems generally display a map in a two-dimensional (2D) manner, and only in certain areas (e.g., a highway interchange), displays a map in one of a three-dimensional (3D) schematic picture and a real still picture to improve traveling direction indication. When drivers drive in unfamiliar places, the 3D picture guidance will demonstrate powerful functions, which is particularly the case when traveling directions are associated with 3D directions including “up” and “down” (e.g., in case of a complex highway interchange system).

However, for this kind of 3D picture guidance technology, the 3D pictures and still photos are all produced in advance, so the onboard GPS positioning and navigation system still needs to store a very large amount of 3D pictures and still photos besides the map data in order to operate properly. Further speaking, as the aforesaid data are mainly pictures of the production time, the onboard GPS positioning and navigation system must be updated at once when actual conditions have changed or even when positions of only a part of marks, marked lines and landmarks for purpose of recognition have displaced, which requires a large amount of time and cost.

Accordingly, a need exists in the art to provide a solution that, in response to demands in practical applications, allows the GPS positioning and navigation system to be used in combination with real-time images in a real-time manner to enhance flexibility of the system without need of storing a great amount of 3D pictures and still photos.

### SUMMARY

An objective of certain embodiments of the present invention is to provide a real-time augmented reality device. The real-time augmented reality device is adapted for use with an image capture device and a navigation device. The navigation device is configured to generate navigation information according to the current location of the navigation device. The image capture device is configured to capture a real-time image comprising an object. The real-time augmented reality device is configured to, according to the navigation information, the real-time image and data contained in the real-time augmented reality device itself, generates a navigation image for the use of navigation by a user.

To achieve the aforesaid objective, the real-time augmented reality device of certain embodiments of the present invention comprises a transceiving interface, a storage and a microprocessor. The microprocessor is electrically connected to the transceiving interface and the storage. The transceiving interface is electrically connected to the navigation device and the image capture device and configured to receive the navigation information and the real-time image. The storage is configured to store the actual length and the actual width of the object. The microprocessor is configured to determine the virtual length and the virtual width of the object in the real-time image, then generate guidance information according to the actual length, the actual width, the virtual length, the virtual width and the guidance information, and finally incorporate the guidance information into the real-time image to generate the navigation image.

Furthermore, to achieve the aforesaid objective, certain embodiments of the present invention further provide a real-time augmented reality method for use in the aforesaid real-time augmented reality device. The real-time augmented reality method comprises the following steps of: (A) enabling the transceiving interface to receive the navigation information and the real-time image; (B) enabling the microprocessor to determine the virtual length and the virtual width of the object in the real-time image; (C) enabling the microprocessor to generate the guidance information according to the actual length, the actual width, the virtual length, the virtual width and the guidance information; and (D) enabling the microprocessor to incorporate the guidance information into the real-time image to generate the navigation image.

Also, to achieve the aforesaid objective, certain embodiments of the present invention further provide a computer storage medium that stores a program for executing the real-time augmented reality method for use in the aforesaid real-time augmented reality device. When the program is loaded into the real-time augmented reality device, the following codes are executed: a code A for enabling the transceiving interface to receive the navigation information and the real-time image; a code B for enabling the microprocessor to determine the virtual length and the virtual width of the object in the real-time image; a code C for enabling the microprocessor to generate the guidance information according to the actual length, the actual width, the virtual length, the virtual width and the navigation information; and a code D for enabling the microprocessor to incorporate the guidance information into the real-time image to generate a navigation image.

Accordingly, when used with the navigation device and the image capture device, the real-time augmented reality device of the present invention may capture the virtual length and the virtual width of an object according to a real-time image of the object, further generate guidance information according to the actual length and the actual width of the object as well as navigation information, and incorporate the guidance information into the real-time image to generate the navigation image. In other words, by obtaining the real-time image, the real-time augmented reality device of the present invention may generate the navigation image in real time without need to store high-cost 3D pictures and still photos. Thereby, shortcomings of the prior art that, beside the need of a large storage space to store the data of 3D pictures and still photos necessary for generating the navigation image, it further needs to update the 3D pictures and still photos in real time in order to maintain the navigation accuracy, thereby causing waste of time and cost, are effectively overcome, and thus the overall added value of the positioning and navigation industry is increased.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view according to a first example embodiment of the present invention;

FIG. 2 is a schematic view illustrating that a car equipped with a real-time augmented reality navigation display system of the first example embodiment is traveling on a road; and

FIG. 3A and FIG. 3B are a flowchart of a real-time augmented reality method according to a second example embodiment of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION

In the following description, the present invention will be explained with reference to example embodiments thereof. However, these example embodiments are not intended to limit the present invention to any specific example, embodiment, environment, applications or particular implementations described in these example embodiments. Therefore, description of these example embodiments is only for purpose of illustration rather than to limit the present invention. It should be appreciated that, in the following example embodiments and the attached drawings, elements unrelated to the present invention are omitted from depiction; and dimensional relationships among individual elements in the attached drawings are illustrated only for ease of understanding, but not to limit the actual scale.

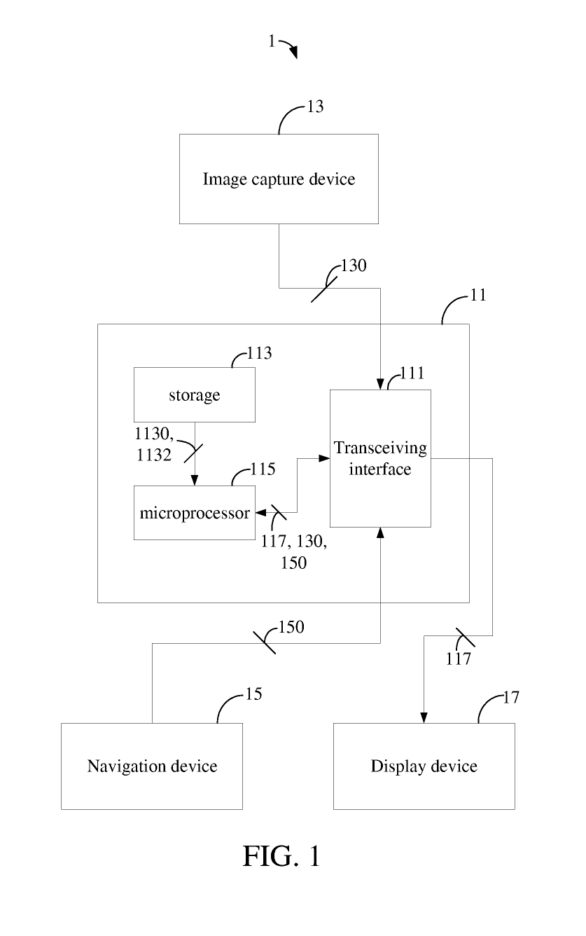

A first example embodiment of the present invention is shown in FIG. 1, which is a schematic view of a real-time augmented reality navigation display system 1. The real-time augmented reality navigation display system 1 comprises a real-time augmented reality device 11, an image capture device 13, a navigation device 15 and a display device 17. In this example embodiment, the real-time augmented reality navigation display system 1 is applied to a car; however, in other example embodiments, the real-time augmented reality navigation display system 1 may also be applied to other vehicles such as airplanes, ships, and locomotives depending on actual requirement of users, and this is not intended to limit the application scope of the present invention. Hereinafter, a description of how the real-time augmented reality navigation display system 1 is implemented by the augmented reality device 11 in combination with the image capture device 13, the navigation device 15 and the display device 17 will be made, followed by the description of functions of the individual devices incorporated in the real-time augmented reality navigation display system 1.

The navigation device 15 of the real-time augmented reality navigation display system 1 is configured to generate navigation information 150 according to a current location of the navigation device 15. The image capture device 13 is configured to capture a real-time image 130 comprising an object. The real-time augmented reality device 11 has an actual length 1130 and an actual width 1132 of the object stored therein, and is configured to generate and transmit a navigation image 117 to the display device 17 according to the actual length 1130, the actual width 1132, the real-time image 130 and the navigation information 150 so that the navigation image 117 may be displayed on the display device 17 for reference by a driver.

It should be noted that, in this example embodiment, the navigation device 15 operates as follows: information such as longitude and latitude, direction, velocity, height and the like of the navigation device 15 per se or the installation location thereof is determined by means of the GPS technology; an inertial navigation system such as an electronic compass, an accelerometer, a gyroscope or the like is used to assist in calculating information during a GPS information update period; and then by using positioning information and map information, the location of the vehicle is located and the traveling path is determined to generate the navigation information 150, which is in nature of two-dimensional information. In other example embodiments, rather than being limited thereto, the navigation device 15 may generate the navigation information 150 by means of other positioning technologies.

Furthermore, the real-time image 130 captured by the image capture device 13 may be inputted in a direct and real-time way; for example, a video camera is equipped in the front of the car. Alternatively, the real-time image may also be inputted in an indirect and non-real-time way; for example, a simulator cockpit may take a recorded image or a computer 3D image derived from the recorded image as the real-time image 130.

For ease of the following description, in this example embodiment, the real-time augmented reality navigation display system 1 is installed in a traveling car. The navigation information 150 generated by the navigation device 15 may be viewed to contain the current location of the traveling car, and the real-time image 130 captured by the image capture device 13 may be viewed as surrounding pictures (e.g., roads, trees and etc.) around the traveling car. The real-time image 130 is the road image viewed by the driver, and the object comprised in the real-time image 130 may be a road separation line viewed by the driver from the front window of the car. Hereinafter, how the real-time augmented reality device 11 generates the navigation image 117 will be described.

As can be known from FIG. 1, the real-time augmented reality device 11 comprises a transceiving interface 111, a storage 113 and a microprocessor 115. The transceiving interface 111 is electrically connected to the navigation device 15, the image capture device 13 and the display device 17. The microprocessor 115 is electrically connected to the transceiving interface 111 and the storage 113. The storage 113 is configured to store an actual length 1130 and an actual width 1132 of the object (i.e., the road separation line).

After the navigation information 150 is generated by the navigation device 15 and the real-time image 130 comprising the road separation line is captured by the image capture device 13, the transceiving interface 111 receives the navigation information 150 and the real-time image 130, and then the microprocessor 115 determines a virtual length and a virtual width of the road separation line in the real-time image 150 according to an object edge recognition method for use in subsequent processing. It should be noted that, the object edge recognition method adopted in this example embodiment may be accomplished by the prior art; however, it is not limited thereto, and in other embodiments, the virtual length and the virtual width of the road separation line in the real-time image 150 may also be determined by the microprocessor 115 in other determining manners.

Subsequently, the microprocessor 115 calculates an elevation angle between an image capturing direction of the image capture device 13 and a horizontal plane according to the actual length 1130, the actual width 1132, the virtual length and the virtual width, and then calculates a deflection angle between the image capturing direction and a traveling direction of the navigation device 15 according to the actual length 1130, the actual width 1132, the virtual length, the virtual width and the navigation information 150. Next, the microprocessor 115 generates guidance information according to the elevation angle, the deflection angle and the navigation information 150, and incorporates the guidance information into the real-time image 130 to generate the navigation image 117. Finally, the microprocessor 115 transmits the navigation image 117 to the display device 17 through the transceiving interface 111 so that the navigation image 117 may be displayed on the display device 17 for reference by the driver.

Specifically, the navigation image 117 is generated by the microprocessor 115 through incorporation of the real-time image 130 with the guidance information. In other words, if the guidance information is an arrow symbol, the real-time image 130 will be incorporated with the arrow symbol, and the navigation image 117 seen by the driver is generated from the real-time image 130 in combination with the guidance information that takes the vertical depth of the visual field angle into consideration. It should be appreciated that, the guidance information may further be other graphics, and this is not intended to limit the scope of the present invention.

In detail, according to regulations of the road law, the actual length and the actual width of the road separation line shall be fixed. After the virtual length and the virtual width of the road separation line are determined, the microprocessor 115 calculates the elevation angle between the image capturing direction of the image capture device 13 and the horizontal plane according to the ratio of the actual length 1130 to the virtual length and the ratio of the actual width 1132 to the virtual width, and further calculates the deflection angle between the image capturing direction of the image capture device 13 and the traveling direction of the navigation device 15 according to the ratio of the actual length 1130 to the virtual length, the ratio of the actual width 1132 to the virtual width and the navigation information 150. Thereby, the guidance information that takes the vertical depth of the visual field angle into consideration may be generated by the microprocessor 115 according to the elevation angle, the deflection angle and the navigation information 150.

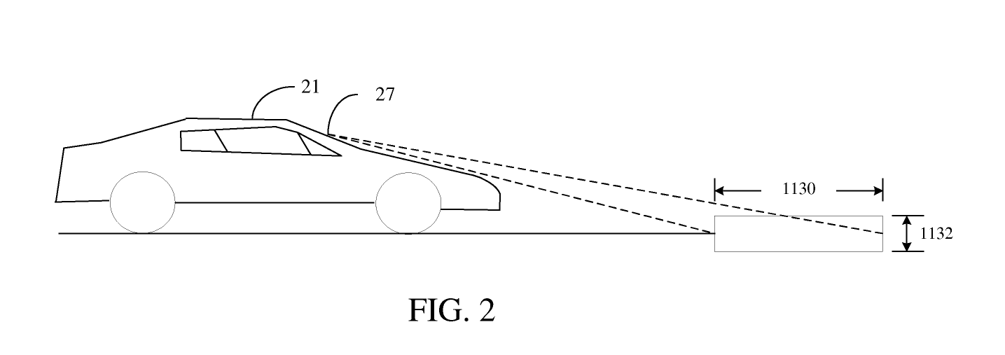

More specifically, referring to FIG. 2, there is shown a schematic view illustrating that a car 21 equipped with the real-time augmented reality navigation display system 1 is traveling on a road. A road separation line 23 having an actual length 1130 and an actual width 1132 lies on the road. The image capture device 13 is configured to capture a real-time image 130 in an image capturing direction viewed from a location 27. The road separation line comprised in the real-time image 130 varies with the traveling direction of the car and the topography or the extending direction of the road. Briefly speaking, the virtual length and the virtual width of the road separation line in the real-time image 130 vary with the traveling direction of the car and the topography or the extending direction of the road.

By continuously determining the virtual length and the virtual width of the road separation line by the microprocessor 115, the deflection angle between the current image capturing direction and the traveling direction of the navigation device 15 as well as the elevation angle between the image capturing direction and the horizontal plane may be continuously calculated in real time so that the microprocessor 115 may convert the two-dimensional navigation information of the navigation device 15 into three-dimensional guidance information. In other words, the microprocessor 115 converts a distance in a two-dimensional map presented by the navigation device 15 into a range in a three-dimensional projection image. As the guidance information is generated in real time according to the elevation angle, the deflection angle and the navigation information 150, when the guidance information is an arrow symbol and a fork shows up abruptly, the arrow symbol may still fall in the middle of the fork properly without offset, thereby to instruct the driver to choose the right way for turning.

It should be emphasized that, the microprocessor 115 generates the guidance information through domain transformation and according to the elevation angle, the deflection angle and the navigation information 150. In other words, a matrix may be calculated according to the data of the elevation angle and the deflection angle, and then a domain transformation is made on the navigation information 150 according to the matrix so that the arrow symbol for use to indicate the road direction is compressed at top and bottom portions thereof by means of the matrix to become guidance information that takes the vertical viewing range into consideration.

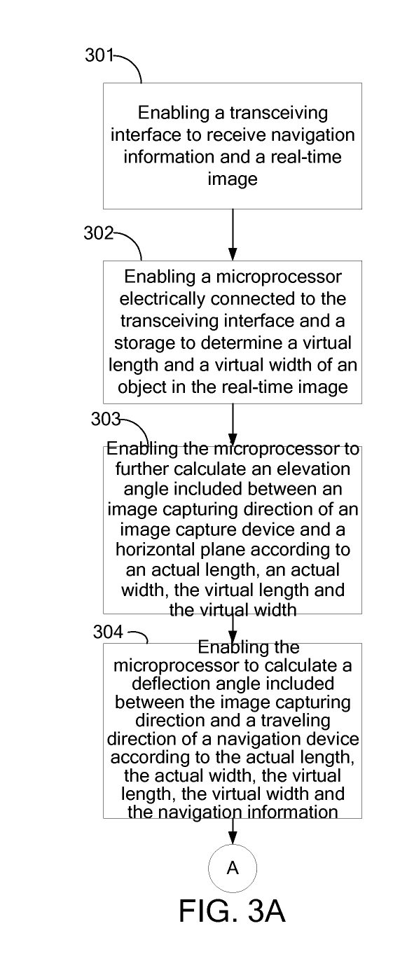

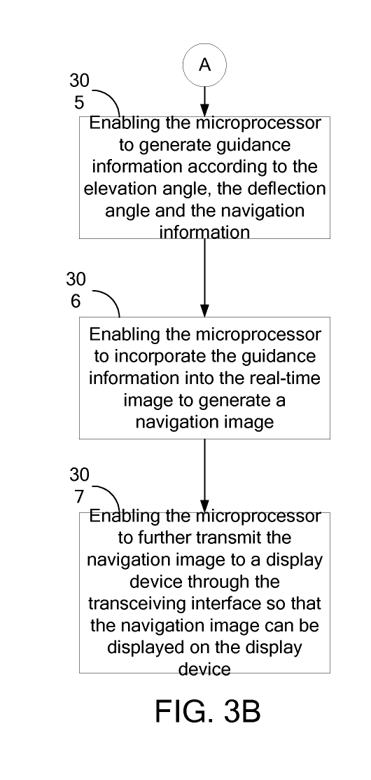

A second example embodiment of the present invention is shown in FIGS. 3A-3B, which illustrates a flowchart of a real-time augmented reality method for use in the real-time augmented reality device of the first example embodiment. The real-time augmented reality device is adapted for use with a navigation device and an image capture device. The navigation device is configured to generate navigation information according to the current location of the navigation device. The image capture device is configured to capture a real-time image comprising an object. The real-time augmented reality device comprises a transceiving interface, a storage and a microprocessor. The transceiving interface is electrically connected to the navigation device and the image capture device. The microprocessor is electrically connected to the transceiving interface and the storage. The storage is configured to store an actual length and an actual width of the object.

Furthermore, the real-time augmented reality method described in the second example embodiment may be implemented by the computer storage medium. When the computer storage medium is loaded into the real-time augmented reality device via a computer and a plurality of codes contained in the computer storage medium is executed, the real-time augmented reality method described in the second example embodiment may be accomplished. This computer storage medium may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

The real-time augmented reality method of the second example embodiment adopts the same technical means as that of the real-time augmented reality device of the first example embodiment. How to realize the real-time augmented reality method of the second example embodiment will be easily known by those of ordinary skill in the art according to disclosures of the first example embodiment. Hence, the real-time augmented reality method will be described only in brief hereinafter.

The real-time augmented reality method of the second example embodiment comprises the following steps. Firstly, referring to FIG. 3A, step 301 is executed to enable the transceiving interface to receive the navigation information and the real-time image. Then, step 302 is executed to enable the microprocessor to determine the virtual length and the virtual width of the object in the real-time image, and step 303 is executed to enable the microprocessor to calculate an elevation angle between an image capturing direction of the image capture device and a horizontal plane according to the actual length, the actual width, the virtual length and the virtual width.

Next, step 304 is executed to enable the microprocessor to calculate the deflection angle between the image capturing direction and the traveling direction of the navigation device according to the actual length, the actual width, the virtual length, the virtual width and the navigation information. Subsequently, referring to FIG. 3B, step 305 is executed to enable the microprocessor to generate guidance information according to the elevation angle, the deflection angle and the navigation information. Then, step 306 is executed to enable the microprocessor to incorporate the guidance information into the real-time image to generate a navigation image. Finally, step 307 is executed to enable the microprocessor to further transmit the navigation image to the display device through the transceiving interface so that the navigation image may be displayed on the display device.

In addition to the aforesaid steps, the second example embodiment may also execute all the operations and functions set forth in the first example embodiment. How the second example embodiment executes these operations and functions will be readily appreciated by those of ordinary skill in the art based on the explanation of the first example embodiment, and thus will not be further described herein.

Accordingly, when used with the navigation device and the image capture device, the real-time augmented reality device of the present invention may capture the virtual length and the virtual width of an object according to the real-time image of the object, further generate guidance information according to the actual length and the actual width of the object as well as navigation information, and incorporate the guidance information into the real-time image to generate the navigation image. In other words, by obtaining the real-time image, the real-time augmented reality device of the present invention may generate the navigation image in real time without need to store high-cost 3D pictures and still photos. Thereby, shortcomings of the prior art that, beside the need of a large storage space to store the data of 3D pictures and still photos necessary for generating the navigation image, it further needs to update the 3D pictures and still photos in real time in order to maintain the navigation accuracy, thereby causing waste of time and cost, are effectively overcome, and thus the overall added value of the positioning and navigation industry is increased.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A real-time augmented reality device adapted for use with a navigation device and an image capture device, the navigation device being configured to generate navigation information according to a current location of the navigation device, the image capture device being configured to capture a real-time image comprising an object, the real-time augmented reality device comprising:
a transceiving interface, being electrically connected to the navigation device and the image capture device, and being configured to receive the navigation information and the real-time image;
a storage, being configured to store an actual length and an actual width of the object; and
a microprocessor, being electrically connected to the transceiving interface and the storage, and being configured to:
determine a virtual length and a virtual width of the object in the real-time image;
generate guidance information according to the actual length, the actual width, the virtual length, the virtual width and the guidance information; and
incorporate the guidance information into the real-time image to generate a navigation image.

2. The real-time augmented reality device as claimed in claim 1, wherein the real-time augmented reality device is further adapted for use with a display device, the transceiving interface is further electrically connected to the display device, the microprocessor is further configured to transmit the navigation image to the display device through the transceiving interface so that the navigation image may be displayed on the display device.

3. The real-time augmented reality device as claimed in claim 1, wherein the microprocessor is further configured to:
calculate an elevation angle between an image capturing direction of the image capture device and an horizontal plane according to the actual length, the actual width, the virtual length and the virtual width;
calculate a deflection angle between the image capturing direction and an traveling direction of the navigation device according to the actual length, the actual width, the virtual length, the virtual width and the navigation information; and
generate the guidance information according to the elevation angle, the deflection angle and the navigation information.

4. The real-time augmented reality device as claimed in claim 1, wherein the microprocessor determines the virtual length and the virtual width of the object in the real-time image according to an object edge recognition method.

5. A real-time augmented reality method for use in a real-time augmented reality device, the real-time augmented reality device being adapted for use with a navigation device and an image capture device, the navigation device being configured to generate navigation information according to a current location of the navigation device, and the image capture device being configured to capture a real-time image comprising an object, wherein the real-time augmented reality device comprises a transceiving interface, a storage and a microprocessor, the transceiving interface is electrically connected to the navigation device and the image capture device, the microprocessor is electrically connected to the transceiving interface and the storage, and the storage is configured to store an actual length and an actual width of the object, the real-time augmented reality method comprising the steps of:
(A) enabling the transceiving interface to receive the navigation information and the real-time image;
(B) enabling the microprocessor to determine a virtual length and a virtual width of the object in the real-time image;
(C) enabling the microprocessor to generate guidance information according to the actual length, the actual width, the virtual length, the virtual width and the guidance information; and
(D) enabling the microprocessor to incorporate the guidance information into the real-time image to generate a navigation image.

6. The real-time augmented reality method as claimed in claim 5, wherein the real-time augmented reality device is further adapted for use with a display device, and the transceiving interface is further electrically connected to the display device, the real-time augmented reality method further comprises the step of:
(E) enabling the microprocessor to transmit the navigation image to the display device through the transceiving interface so that the navigation image may be displayed on the display device.

7. The real-time augmented reality method as claimed in claim 5, wherein the step (C) comprises the steps of:
(C1) enabling the microprocessor to calculate an elevation angle between an image capturing direction of the image capture device and a horizontal plane according to the actual length, the actual width, the virtual length and the virtual width;
(C2) enabling the microprocessor to calculate a deflection angle between the image capturing direction and a traveling direction of the navigation device according to the actual length, the actual width, the virtual length, the virtual width and the navigation information; and
(C3) enabling the microprocessor to generate the guidance information according to the elevation angle, the deflection angle and the navigation information.

8. The real-time augmented reality method as claimed in claim 5, wherein the step (B) is a step of enabling the microprocessor to determine the virtual length and the virtual width of the object in the real-time image according to an object edge recognition method.

9. A computer storage medium storing a program for executing a real-time augmented reality method for use in a real-time augmented reality device, the real-time augmented reality device being adapted for use with a navigation device and an image capture device, the navigation device being configured to generate navigation information according to a current location of the navigation device, and the image capture device being configured to capture a real-time image comprising an object, the real-time augmented reality device comprising a transceiving interface, a storage and a microprocessor, the transceiving interface being electrically connected to the navigation device and the image capture device, the microprocessor being electrically connected to the transceiving interface and the storage, and the storage being configured to store an actual length and an actual width of the object, and when the program is loaded into the real-time augmented reality device via a computer, the following codes being executed:
a code A for enabling the transceiving interface to receive the navigation information and the real-time image;
a code B for enabling the microprocessor to determine a virtual length and a virtual width of the object in the real-time image;
a code C for enabling the microprocessor to generate guidance information according to the actual length, the actual width, the virtual length, the virtual width and the navigation information; and
a code D for enabling the microprocessor to incorporate the guidance information into the real-time image to generate a navigation image.

10. The computer storage medium as claimed in claim 9, wherein the real-time augmented reality device is further adapted for use with a display device, the transceiving interface is further electrically connected to the display device, and when the program is loaded into the real-time augmented reality device via the computer, the following code is further executed:
a code E for enabling the microprocessor to transmit the navigation image to the display device through the transceiving interface so that the navigation image may be displayed on the display device.

11. The computer storage medium as claimed in claim 9, wherein the code C comprises:
a code C1 for enabling the microprocessor to calculate an elevation angle between the image capturing direction of the image capture device and a horizontal plane according to the actual length, the actual width, the virtual length and the virtual width;
a code C2 for enabling the microprocessor to calculate a deflection angle between the image capturing direction and a traveling direction of the navigation device according to the actual length, the actual width, the virtual length, the virtual width and the navigation information; and
a code C3 for enabling the microprocessor to generate the guidance information according to the elevation angle, the deflection angle and the navigation information.

12. The computer storage medium as claimed in claim 9, wherein the code B is a code for enabling the microprocessor to determine the virtual length and the virtual width of the object in the real-time image according to an object edge recognition method.
